(19) United States
(12) Patent Application Publication
(10) Pub. No.: US 2010/0278538 A1
(43) Pub. Date: Nov. 4, 2010

(54) MILLIMETER WAVE WIRELESS COMMUNICATION SYSTEM

(75) Inventors: Daniel Guidotti, Atlanta, GA (US); Gee-Kung Chang, Atlanta, GA (US); Shu-Hao Fan, Atlanta, GA (US); Arshad Chowdhury, Atlanta, GA (US); Hung-Chang Chien, Atlanta, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Georgia Tech Research Corporation, Atlanta, GA (US)

(21) Appl. No.: 12/769,280

(22) Filed: Apr. 28, 2010

Related U.S. Application Data
(60) Provisional application No. 61/173,737, filed on Apr. 29, 2009.

(51) Int. Cl. H04B 10/00

(52) U.S. Cl. 398/115; 398/130

(57) ABSTRACT

A wireless communication system adapted to transmit data between two locations, for example between a plurality of processors and memory. Digitally coded millimeter waves can be used to transfer data between antenna arrays. A global optical clock can provide network coherence, frequency self-tracking, and a local oscillator signal for data digital symbol coding/decoding and symbol up-down conversion to/from the millimeter wavelength carrier.

### CROSS REFERENCES TO RELATED APPLICATIONS

This application claims benefit of priority under 35 U.S.C. §119(e) of U.S. Provisional Patent Application No. 61/173,737, filed 29 Apr. 2009, the entire contents and substance of which are hereby incorporated by reference as if fully set forth below.

### BACKGROUND

Embodiments of the present invention relate to a wireless communication system and, more particularly, to a millimeter wave wireless communication system configured to wirelessly transmit data from one point to another.

Cyber physical systems (CPS) include the orchestration of computation and logic, actuation of physical devices, and awareness and feed-back from sensor networks. Embedded computers can monitor, coordinate, and control physical processes through sensors and feedback loops that communicate through layered networks. The economic and societal potential of such systems has been recognized as being profound, and major investments are being made worldwide, for instance in the research and development of the technology.

High performance CPS find applications in, for example and not limitation, integrated medical systems such as robotic surgery in which the cyber unit not only regulates the actuation of various robotic arms, but also consistently runs sanity checks. These sanity checks monitor patient vital signs through various sensors, and may use visual pattern recognition of the procedure and compare with stored visual procedure data, while being “aware” of the critical aspects of the surgery and provide non-intrusive voice cues during delicate and critical moments in the procedure or un-expected changes or deviations from the norm.

Conventional computer hardware components are based on three pervasive technologies, silicon for transistors in logic operations, storage memory, and signal amplification; copper for conductive data transmission; and composite materials for off-chip insulators in discrete component integration. Except for the slow evolution of composite insulators, there are no effective or economical alternatives to the silicon-based complimentary metal oxide semiconductor (CMOS) transistor fabrication process or to the copper transmission line. While extended longevity can be derived from CMOS hardware with the advent of multi-core processors, parallel and concurrent execution of instructions as well as the evolution of software to optimize performance without hiding latencies, the same cannot be said for off-chip data transport for which there seems to be no immediate alternative to the legacy copper transmission line. Accordingly, communication systems, in particular those that are internal to a computer, are limited to the performance of digital copper transmission.

### SUMMARY

Briefly described, embodiments of the present invention relate to a wireless communication system that includes a transceiver system that operates in conjunction with an optical clock. The transceiver system can be adapted to operate within the millimeter wave range.

Embodiments of the present invention further relate to a wireless data bus for the transaction of data between digital processors and DRAM main memory. Digitally coded millimeter waves can be used to transfer data between antenna arrays, for example via near field transmission. A global optical clock can provide network coherence, frequency and phase self-tracking, and a local oscillator signal for data digital symbol coding/decoding and symbol up-down conversion to/from the millimeter wavelength carrier.

Embodiments of the present invention relate to high performance systems. In some embodiments, these high performance systems are configured to enable a compact, modular cyber unit to become pluggable and therefore pervasive by introducing the concept of the wireless data bus, operating in the millimeter wavelength band.

Embodiments of the present invention relate to advancing the ubiquity of high performance cyber units by introducing the concepts of the processor sub-mount and the main memory sub-mount. In some embodiments, the two exchange high volumes of data via the wireless data bus architecture. The wireless data bus favors modular plug-and-play integration in which the processor and memory sub-mounts can be treated as separate sub-assemblies that plug into a conventional, low speed, input/output interface bus, a high speed optical bus, or the like, via standardized interfaces for connectedness into the cyber physical system network.

In one aspect, a wireless communication system is configured to transmit data from a first location to a second location. The wireless communication system comprises an optical signal providing network coherence, frequency self-tracking, and a local oscillator signal for data digital symbol coding/decoding and symbol up-down conversion; and a communication device configured to operate in conjunction with the optical signal.

In another aspect, a radio frequency (RF) system comprises a plurality of RF channels adapted to transmit data between two locations in space, each of the plurality of RF channels comprises a transmitter element and a receiver element; and an optical signal configured to be distributed to each transmitter and receiver element of the plurality of radio frequency channels.

In yet another aspect, a wireless communication system comprises a first substrate adapted to carry a plurality of processors on a first surface, wherein the plurality of processors are in electrical communication with a transceiver on a second surface; a second substrate adapted to carry a plurality of storage media on a first surface, wherein the plurality of storage media are in electrical communication with a transceiver on a second surface; and an optical signal fed to the first and second substrates.

These and other objects, features, and advantages of the present invention will become more apparent upon reading the following specification in conjunction with the accompanying drawings.

### BRIEF DESCRIPTION OF THE DRAWINGS

FIG. 1A illustrates a perspective view of a processor board and a memory board being distant from one another and an optical clock providing a source of many frequency functions, in accordance with an exemplary embodiment of the present invention.

FIG. 1B is a cross-sectional view of the processor board, in accordance with an exemplary embodiment of the present invention.

FIG. 1C is a partial top view of a Vivaldi antenna.

FIG. 2 is a partial cross-sectional view of the processor board and the memory board of FIG. 1A, in accordance with an exemplary embodiment of the present invention.

FIG. 3 is a diagram of a network of cyber physical sub-systems, in accordance with an exemplary embodiment of the present invention.

FIG. 4A is a snapshot of a receiver antenna in wireless communication with a transmitter antenna, in accordance with an exemplary embodiment of the present invention.

FIG. 4B is a measurement of an eye opening diagram of a received data stream at approximately 10 Gb/s, in accordance with an exemplary embodiment of the present invention.

FIG. 5A is a schematic of a wireless communication system, in accordance with an exemplary embodiment of the present invention.

FIG. 5B is a plan view of a plurality of wireless communication systems, in accordance with an exemplary embodiment of the present invention.

FIG. 6 is a perspective view of the processor board being distant and adapted to be in communication with the memory board, in accordance with an exemplary embodiment of the present invention.

FIG. 7 is another schematic of a wireless communication system, in accordance with an exemplary embodiment of the present invention.

FIG. 8A is a measurement of a received signal in relative phase relation (φ) with a local oscillator signals for the transmitting and receiving channels that can be systematically varied between about 0° and 90°, in accordance with an exemplary embodiment of the present invention.

FIG. 8B is a measurement the received signal as a Mach-Zehnder (MZ) modulation frequency f is de-tuned by about 100 MHz out of about 10 GHz, or approximately 1%, when both the transmitter and receiver channels are optimized for about 40 GHz local oscillator operation, in accordance with an exemplary embodiment of the present invention.

### DETAILED DESCRIPTION

To facilitate an understanding of the principles and features of various embodiments of the present invention, they are explained hereinafter with reference to their implementation in an illustrative embodiment. In particular, an illustrative embodiment of the invention is described in the context of being a wireless communication system. The wireless communication system can use of the frequency provided by an optical clock and thus reduce the number of components that a conventional wireless communication system requires. In some embodiments, the wireless communication system is configured to operate in a millimeter wave range.

Embodiments of the invention are not, however, limited to a wireless communication system. Embodiments of the present invention can be used to provide an optical clock to control a wireless communication system, means to convert an optical clock to an electrical clock, and/or a means of enabling a processor board to wirelessly communicate with a memory board and thus improve communication, e.g., speed up and lower power consumption, between a processor and memory that it interfaces with.

The materials and components described hereinafter as making up the various elements of the present invention are intended to be illustrative and not restrictive. Many suitable materials and components that would perform the same or a similar function as the materials and components described herein are intended to be embraced within the scope of the invention. Further, such other materials not described herein can include, but are not limited to, materials that are developed after the time of the development of the invention, for example.

Referring now to the figures, wherein like reference numerals represent like parts throughout the view, embodiments of the present invention will be described in detail.

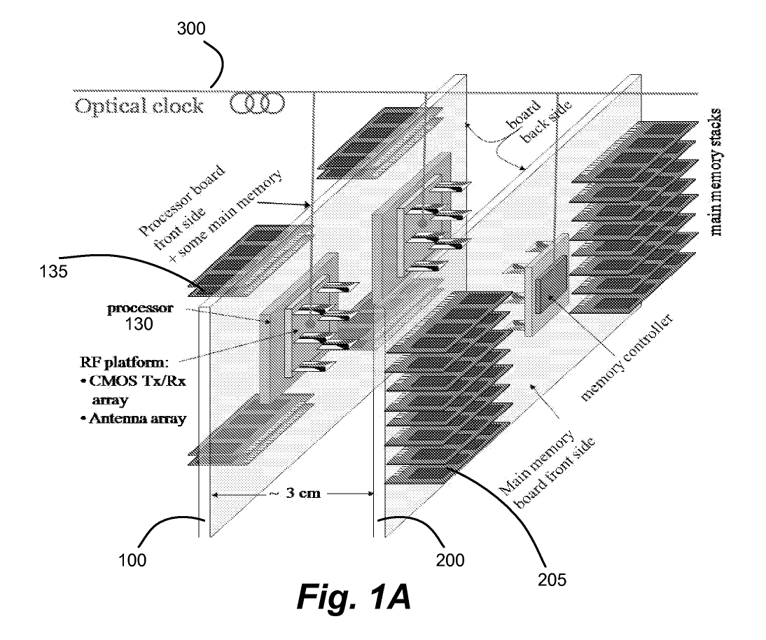

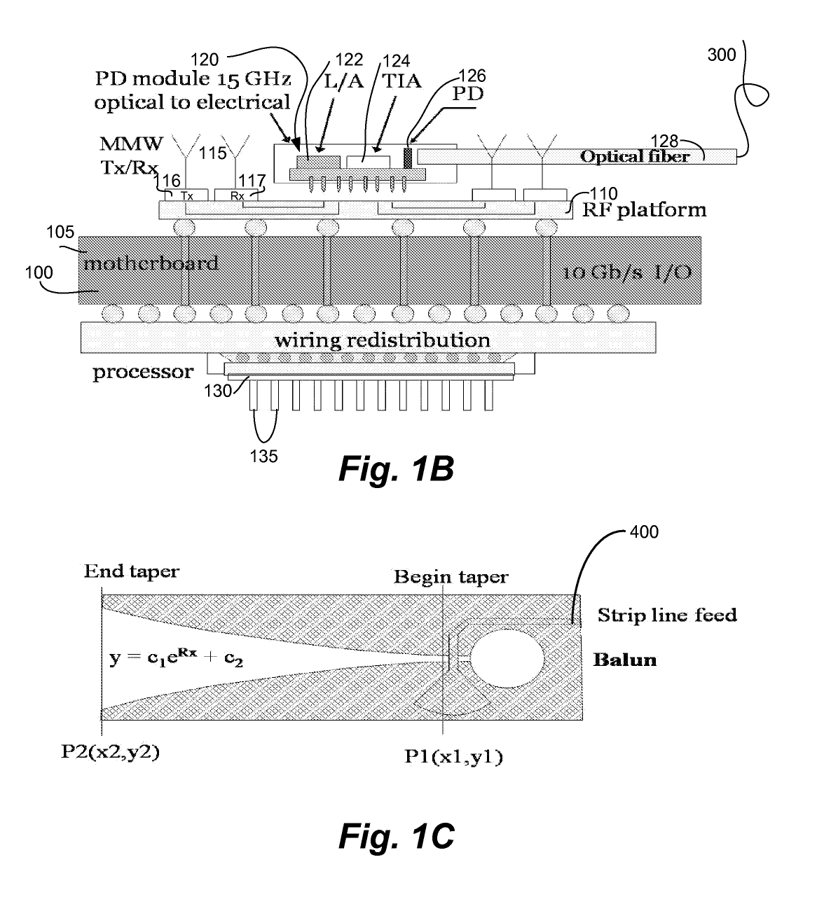

Referring now to FIGS. 1A-1B, in some embodiments of the present invention, a millimeter wave (mmw) wireless data access network includes multiple modules for the processing of data being housed on a first substrate 100 with some memory 135 for storing data. In addition, a large memory storage 205 can be housed on a second substrate 200. The first substrate 100, which can be a processor board, and the second substrate 200, which can be a memory board, can exchange data at high rates via a mmw wireless bus. The mmw wireless bus comprises radio frequency (RF) integrated circuit (IC) transceiver (Tx/Rx) arrays, and antenna radiator arrays that are mounted on a RF platform on the back of the respective boards. Phase relation between the Tx and Rx channels, φ, may be designed as a fixed delay transmission line on the RF platform or as a programmable phase delay on the IC. Various through-vias of each board 100/200 provide direct one-to-one input/output (I/O) connections between the processor I/Os (or memory node I/Os) and the respective RF Tx/Rx platform on the corresponding board. Further, a globally distributed optical clock 300 can provide an approximate 15 GHz correlated local oscillator (LO) signal, whereby eliminating integrated circuit (IC) component redundancy, which can consequently increase RF IC manufacturing yield and reduce power dissipation. In some embodiments, only one optical drop per processor (or memory node) need be implemented.

FIG. 1A illustrates a processor board 100 and a memory board 200 in a face back-to-back orientation. The boards 100/200 are configured to transmit data wirelessly via a wireless hub, for example via near field coupling. An optical clock 300 can provide frequency self tracking and correlated LO signals to each Tx/Rx unit throughout the network. FIG. 1B, on the other hand, illustrates an optical drop in more detail and in a cross-section view of a packaged processor-to-RF platform electrical vias though the motherboard of the processor board 100. A single optical drop on the RF platform provides approximately 15 GHz electrical LO input to all Tx/Rx ICs on the RF platform.

Referring to FIG. 1B, a partial cross-sectional view of the processor board 100 is illustrated. The processor board 100 includes a motherboard 105 that is capable of carrying all the elements of the processor. A first side of the motherboard 105 is in electrical communication with the RF platform 220. The RF platform 220 carries the transceiver 115, which can include both transmitter element (Tx) 116 and a receiver element (Rx) 117, each of which including an antenna that may be shared in time sequence between Tx and Rx to either transmit or receive wireless signals. The RF platform 220 is in electrical communication with the photo detector (PD) module 120. The PD module 120 can include a limiting amplifier 122, a transimpedance amplifier 124, and a photo detector 126.

The optical clock 300 can be in communication with the photo detector module 120. The PD module 120 receives the optical clock via, for example and not limitation, an optical fiber 128. The photo detector 126 can convert the optical clock signal 300 to an electrical signal for use by each transmitter element 116 and each receiver element 117 in the wireless hub on the RF platform 220. The processor 130 can occupy a portion of the opposite surface of the motherboard 105.

The opposing side of the motherboard can carry a plurality of processors 130. Each of the processors 130 can be in communication with its own separate RF board with its own hub of wireless RF transmitters and receivers. The processors 130 can be in communication with a different section of the memory board 200, for example as described in more detail throughout.

Basic mmw components have been developed to varying degrees for other applications. For example, CMOS RF transceiver ICs have been developed for wireless personal area network (PAN) applications at many universities and start-up companies. These mmw transceivers are generally limited to less than an approximate 10 GHz bandwidth and less than an approximate 10 Gb/s data throughput with about 370 mW power dissipation. This level of power dissipation per channel is not considered acceptable for a dense, wireless, main memory data bus.

By using a global optical clock 300, in embodiments of the present invention, power dissipation can be reduced to approximately 8-11 mW/Gb/s, a level that is commensurate with present copper bus technology.

In some embodiments, a Vivaldi antenna can be implemented to enable the wireless communication. The Vivaldi antenna is an aperiodic, continuously scaled, traveling wave, tapered, slot line antenna with a balun structure to impedance match the single ended strip line feed to the differential slot line propagation structure. Strictly speaking, such antennas whose slot flares open with an exponential dependence on distance from the antenna feed are considered Vivaldi antennas. Over the years other rates of flare opening, polynomial, liner, stepped have also become associated with this name. The general characteristics of Vivaldi antennas include operation over a wide frequency bandwidth, symmetric, end-fired beam of EM radiation having low side-lobes, and moderate gain. A schematic of a Vivaldi antenna is shown in FIG. 1C. As shown in FIG. 1C, the schematic of the Vivaldi antenna includes a strip line feed 400 that is separated from the top and bottom electrodes, which are generally identical, except in the case of antipodal electrodes.

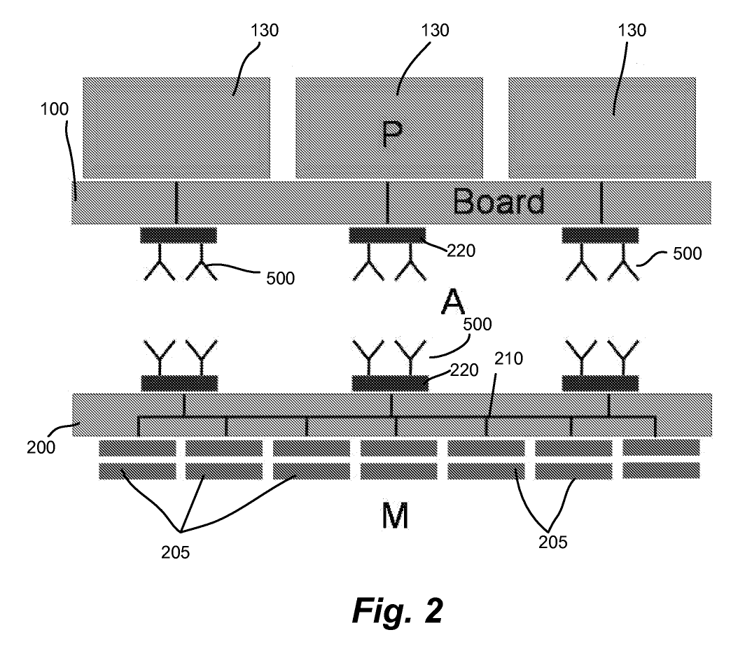

Referring now to FIG. 2, in some embodiments, the millimeter wave bus can support a data throughput that is much greater than what is possible with the most advanced legacy copper bus and with similar or less power dissipation. The wireless optical bus also promotes strong physical locality of data by substantially increasing the volume of main memory accessible to one or multiple processors within the same wiring hierarchy.

The memory bandwidth, or the number of Bytes per second of data that can be moved between a volume of DRAM and a processor, can be influenced by at least three transport factors. A first influence is the intrinsic memory latency, measured in processor clock cycles required to “fetch” a set of column data from the cell array and have it ready at output. The reverse sequence applies to the “put” operation. A second influence can be the transport bandwidth, which can be in Bytes per second, used to move data over the distance between the nearest main memory volume and a processor. The third influence is the distance between a processor and main memory.

The simultaneous proliferation of multi-core processors and concurrent parallel multiple thread computing favors that main memory capacity be close to the processor and that it be accessible at high rates so as to minimize the number of idle clock cycles that a processor must wait for “put” and “fetch” operations to complete, a circumstance sometimes referred to as the von Neumann bottleneck.

The amount of memory that can be packed close to the processor can be limited by footprint contention between the packaged processor and memory modules. It may also be limited by the signaling propagation distance attainable by legacy copper bus technology. The copper bus limits both the access bandwidth and the volume of main memory accessible to a processor over a common wiring hierarchy. These trends make it difficult to scale cyber physical systems to substantially higher performance.

The memory bottleneck can be an impairment often considered second to heat dissipation in that memory bandwidth and DRAM latency become the performance-limiting factor for many applications and often results in sustained application performance that is only a few percent of peak performance in large scale systems.

In some embodiments, the millimeter wave data bus can enable scalable throughput by means of high order digital coding, strong main memory spatial locality by increasing the available memory on the same interconnect hierarchy, and more efficient programming by naturally facilitating a shared memory architecture without overhead latency from hand-off protocol to a different level of interconnects.

A sketch of a potential implementation of the millimeter wave bus is illustrated in FIG. 2. As shown in FIG. 2, a first substrate (e.g., a blade or board) is positioned near a second substrate. For example, the first blade 100 can be a processor sub-mount, and the second blade 200 can be a main memory sub-mount. The processor sub-mount 100 can house a plurality of processors (P) 130 that can share the same volume of main memory (M) 205 located on a neighboring main memory sub-mount 200. The transmitting and receiving antenna arrays (A) 500 can be placed on a back side of each sub-mount 100/200, and can be used to exchange multiplexed data at high rates over multiple or single channels, depending on requirements. On the memory board 200, data is fetched from various storage media 205, for example and not limitation DRAM cells, over copper buses 210 to the millimeter wave module 220, where it can be multiplexed prior to wireless transmission by the antenna arrays (A) 500. On the other hand, data can be stored in main memory by reversing this process.

Compact, modular high performance cyber physical systems (CPS) can become the next bench-mark for the CPS infrastructure in efficiently managed transportation grids, semi-automated metropolitan health networks and energy grid management, problem anticipation and prediction, and the activation and monitoring of preventive protocols.

Transformative hardware innovations can be made in principally three areas: (1) diminution and management of dissipated power in the CPS network, (2) increased computational performance and efficiency of the syber units, and (3) standardized network interfaces between sensors, physical actuators and cyber units. Standard interfaces facilitate plug-and-play modularization, efficient repair, and upgrade. An exemplary manner to increase performance and efficiency of the cyber unit is to increase the bandwidth of off-chip data transport. The millimeter wave data bus, when used in near field coupling and in conjunction with an optical synchronizing clock is projected to function within the power budget of the most advanced copper data bus and at a much higher throughput.

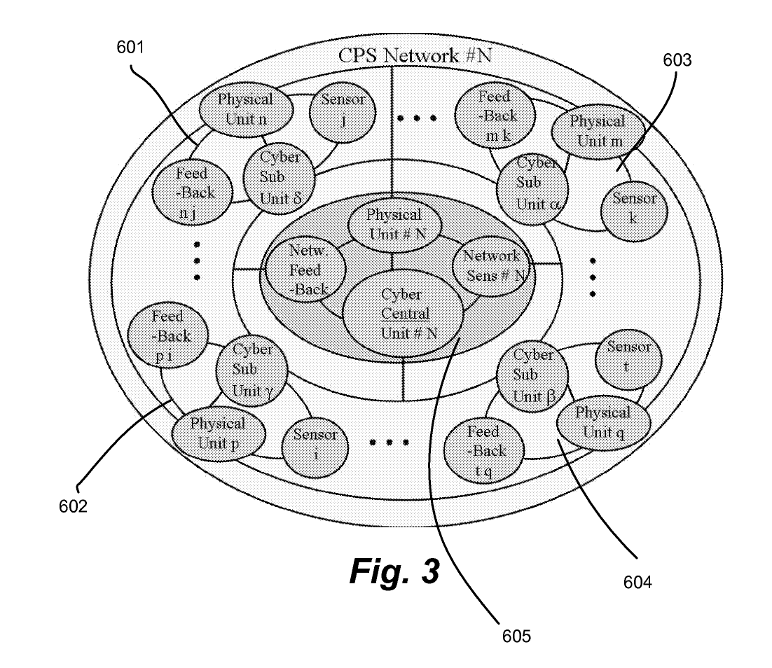

The network of cyber physical sub-systems depicted in FIG. 3 is a general concept that may be found in the operation and control of critical systems.

A CPS network is generally illustrated in FIG. 3. The cyber, physical and sensor/feedback units can be incorporated in each local CPS sub-network, which is represented by the four linked circles 601, 602, 603, and 604, as well as in the CPS central network that manage, monitor, and intervene, as needed in the operation of a particular sub-network when an errant parameter falls outside its allowable deviation.

For example and not limitation, in a submarine a CPS network having the four linked circles, as again illustrated in FIG. 3, may manage the reactor and heat exchanger, steam generator, and the steam turbine functions. This CPS network may be interfaced to another CPS sub-system that manages external sensors and communication, and is cognizant of the three-dimensional terrain for hundreds of miles and may independently initiate evasive protocol. These CPS sub-systems along with other less critical ones may be monitored, managed, and over-ridden, if necessary, by at least one CPS central network 605, shown at the center of FIG. 3, and at least one back-up CPS central network. Independent redundant networks can run simultaneously in the background for fail-safe applications.

Not all CPS networks require a compact, high bandwidth cyber central unit. Cases in which high computational performance is critical in order to act on sensor data and actuate a physical unit in a time-limited sequence may include those applications acting on many degrees-of-freedom, where frequent adaptive mesh simulations may be required to execute rapidly and often, in order to estimate a most probable outcome in a limited time interval prior to physical actuation.

Embodiments of the present invention relate to a system enabling data to be transported between a processor and main memory with unprecedented bandwidth by means of electromagnetic waves in the millimeter wave (mmw) band transmitted over the near-field interaction between two arrays of antennas.

In some embodiments, the single channel throughput can be determined by the symbol rate and the number of bits that can be carried by each symbol, which in turn can be determined by the digital modulation protocol. The symbol rate may be limited by the channel frequency bandwidth, while the bit error rate (BER) can be determined by the signal-to-noise ratio (SNR) in the channel. The theoretical BER in the data transmission can be estimated from the fundamentals of data communication, the digital modulation method of choice, and the projected SNR. The technical concept that makes the mmw data bus feasible and dissipate low power can include the distribution of a common-source optical local oscillator (LO) over the network of mmw transceivers.

The global optical clock 300 can provide phase coherence, frequency self-tracking, and IC component frugality, while minimizing power dissipation. In some embodiments, the power dissipation can be equivalent to that of a copper bus, or even less. In some embodiments, a potential per-channel data transport bandwidth can be about 40×10⁹ bits per second (b/s), which is about 2.5 times that for the most aggressive contemporary copper bus technology. The throughput of the aggregate mmw bus can be determined by the number of wireless channels in the bus and the single channel throughput. The number of mmw channels that can fit within the foot-print of a packaged processor can be approximately 64, for example in the case of a single processor having multiple cores mounted on a single processor wiring re-distribution package, or twice or three times that number in the case of a single processor having multiple cores mounted on a substantially larger multi-chip module (MCM) that may also contain off-chip memory cache. In this case, the aggregate bandwidth can correspond to about twice or four times or six times the width of the copper bus. Furthermore, in some embodiments, depending on the implemented geometry, the result can be approximately a five-fold increase in the volume of main memory within the footprint of the packaged processor.

A transport architecture for moving data between processors and main memory permits the scalability of bandwidth with processor development. A legacy copper bus includes signaling transmission lines and the movement of charge. Individual bits of data are transmitted with an efficiency of one bit per symbol. A bit “1” can be transmitted when the line is fully charged to a logic voltage level +V, and a bit “0” can be transmitted when the line is fully discharged. Intermediate voltage levels are possible and have been demonstrated for more efficient signaling, but are seldom used in practice.

A legacy copper bus works well when signaling at low rates of the order of approximately 1×10⁹ b/s. When the signaling rate approaches 10×10⁹ b/s, however, the intrinsic properties of the transmission line, related to the skin effect and the self-inductance of the line, the bits can become temporally broader and weaker at the end of the line, compared to their width and voltage level at the beginning of the line, and individual bits may begin to overlap. The individual bits can become more difficult to distinguish and the probability for correctly binning each bit in the original sequence decreases. In addition, the transmission line can rest on an insulating substrate that may have an even greater detrimental effect on the signaling integrity. This may have to do with the way the substrate interacts with the charging and discharging of the transmission line. At relatively low frequencies, for example less than approximately 1×10⁹ b/s, there may be little interaction and the substrate can perform like a passive insulator. As the signaling frequency increases to approximately 10×10⁹ b/s or above, the detrimental effects increases. The electric dipoles of the insulator atoms can become polarized and driven by the alternating electric field that loses energy due to internal damping intrinsic to dielectric polarization in the insulator. The electric polarization of the insulator, the dipole coupling to the external field, and the energy loss can all be slightly different at each frequency. This manifests as dispersion in the speed of signal propagation and the power loss of the transmission line. Because a square digital pulse can be de-convolved into constituent odd harmonics, the energy carried by each constituent frequency propagates at a slightly different speed, becomes slightly phase shifted, and its energy content is absorbed slightly differently than that of a next constituent frequency. As a result, a square digital pulse can become wider and weaker as it propagates along the transmission line. The substrate dispersion effects can be stronger and more limiting than, for example, those associated with the copper transmission line alone. The net consequence for data transport over a copper bus that is useful signaling distance can be greatly reduced. Fortunately, these effects are predictive and fixes such as signal pre-distortion, active amplitude equalization, and clock recovery can slow the rate of decrease in the useful signaling distance as the signaling bit rate continues to increase.

Parenthetically, the width of the copper bus cannot be increased in order to achieve higher aggregate throughput without penalty. As the width of the bus increases, so does the required overhead in the number of signal, power and ground I/Os required, especially if differential impedance lines are used, as they must. Power dissipation also increases as function of corrective ICs for clock recovery, active equalization and pre-emphasis. While low attenuation and low dispersion substrate materials have existed for many years, these have not found their way into volume motherboard manufacturing.

A potential alternative to the copper bus is the optical bus. Again, the bit transmission efficiency is one bit per symbol. In this case, bits are encoded as “light on” for bit “1” and light off for bit “0.” One advantage of the optical bus is that the signaling distance may be from a few centimeters to a few meters over either multimode optical fibers or polymer waveguides without detrimental signal attenuation or distortion for certain wavelength bands.

On the other hand, a drawback of the optical bus is that it dissipates more energy per bit than a copper bus at a signaling rate around 10×10⁹ b/s and higher. Another drawback is that in order to make the development effort provide a valuable return of investment, and to justify a higher power budget, the optical signaling rate should preferably be at least two or three times that achievable for copper. New lasers preferably can be directly modulated at approximately 20 and 30×10⁹ b/s with sufficient reliability. This may be an expensive and uncertain undertaking. Finally, the optical bus continues to lack a demonstrated integration process that is mass producible, reliable and economical.

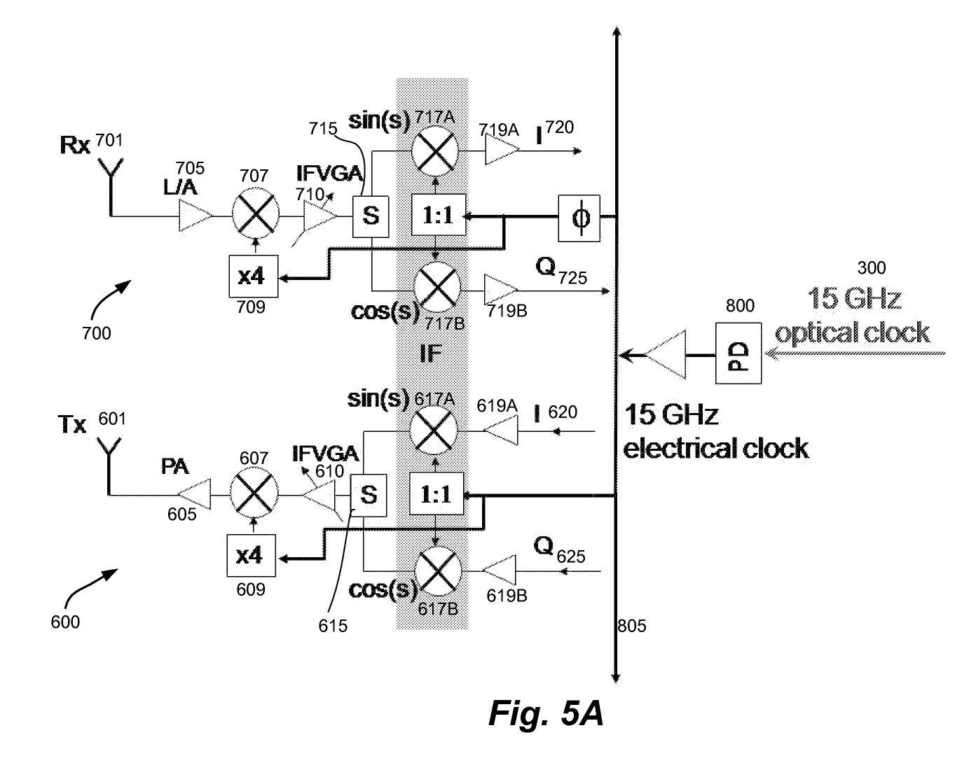

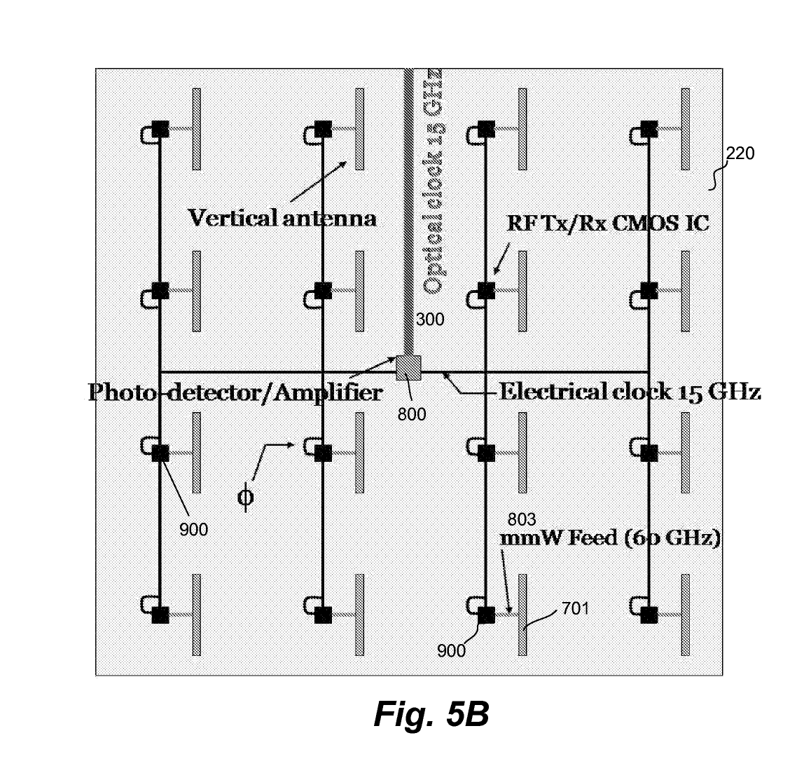

The mmw memory access bus of the present invention can be applicable to the transactions of “put” and “fetch” between main memory and a processor. Key features of the memory access network are that it is closed, static, and wireless. A memory transaction proceeds through a memory controller or hub that manages the access timing to data in a specific volume of DRAM, readies to transfer data at the I/O pins, and in this architecture can turn on the appropriate number of mmw transmitter and receiver channels, depending on the size of the data stream to be transferred. Turning on a channel means that power is supplied to the appropriate CMOS mmw mixers, amplifiers and active filters, as illustrated in FIG. 5A. The data stream can be encoded onto the carrier mmw in a mixer IC circuit, for example in real time, and transmitted by the antenna transmitter, Tx, for example again in real time.

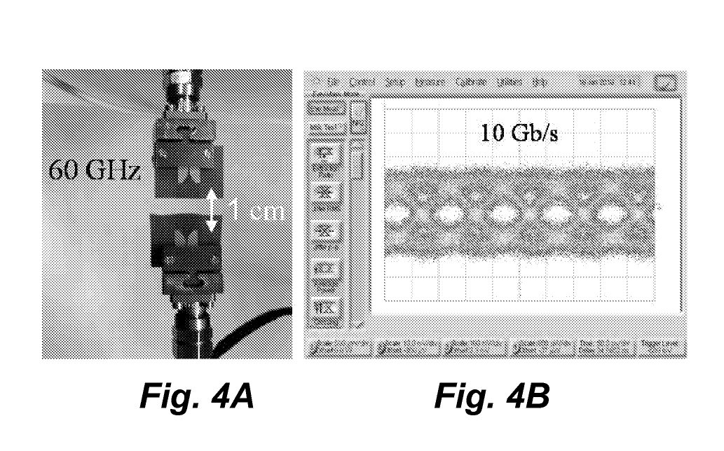

As shown in FIG. 4A, receiving antenna, Rx, can receive the coded mmw via near field coupling, down-convert the digital data stream in a receiving mixer, amplify and filter the digits as necessary, and send the data directly to the destination, for example in real time.

FIG. 4A displays a near field data transmission between two Vivaldi antennas, each of which mounted on a V-type SMA end-launcher. The antenna electrodes can be defined by etching a copper pattern on a copper plated, thin liquid crystal polymer substrate. The ground electrode can be visible on each antenna. The second electrode can be formed on the opposite side. A measurement of an eye opening of the received data stream at approximately 10 Gb/s is shown in FIG. 4B.

In some embodiments, the receiving mmw IC can amplify the received carrier wave before it is demodulated by a second mixer and low pass filter to retrieve the data stream, see, e.g., FIG. 5A. In the case of higher order symbol coding, the transmitter and receiver may each have two orthogonal channels for amplitude and phase encoding and detection, generally referred to as the “in-phase” or “I” and “quadrature” or “Q” channels. Full advantage can be taken of the fact that the network can be static and closed. “Static” means the absence of relative motion between Tx and Rx that greatly simplifies matters vis a vis mobile wireless networks. “Closed” means that the network is finite and bounded. An advantage of a closed, static network is that it can be connected by a global optical clock.

As mentioned above, in embodiments of the present invention, an optical clock 300 from a single source can be conveniently distributed throughout the network via, for example and not limitation, an optical fiber. At least one optical clock drop can be used for the volume of memory controlled by each memory controller or hub. The optical clock signal can be converted to an electrical clock signal and distributed electrically from the optical drop, as shown in FIG. 5B, to all the Tx and Rx CMOS modules on the RF platform 220, which can be under the control of each memory controller. The common source optical clock can maintain network coherence in that it correlates each Tx/Rx pair as it provides the LO signal.

Consequently, with the optical clock source 300 a number of conventional circuit elements may become redundant and can be eliminated. For example and not limitation, a frequency synthesizer, phase locked-loop (PLL) and voltage controlled oscillator can be removed or eliminated from the ultimate design. Removing redundant components from the IC module simplifies Tx/Rx module manufacturing, improves yield, and reduces power dissipation. In addition, using near field transmission of bits requires lower power, and can reduce cross talk and scattering. The main components of the super-heterodyne architecture that make up the Tx/Rx pair IC module for “I” and “Q” modulation are shown in FIG. 5A, while an array of such modules with antennas, as might be assembled on a mmw RF platform with an optical clock drop and electrical clock distribution, is shown in FIG. 5B.

The mmw data bus includes principally of two distinct technology components, an integrated semiconductor circuit and an antenna. The IC circuit includes transistors whose switching can be used to mix oscillating electric fields to generate sum and difference frequencies. Other transistors can be operated in their linear response region to linearly increase the alternating current level of an incident signal. Conductive, strip-line type features can be used to attenuate certain frequencies while not attenuating others. These filtering elements can be compatible with the back-end-of-the-line CMOS process and, along with mixers and amplifiers, constitute the basic components for wireless radio transmission and reception. When transistors are made responsive to mmw frequencies, then the radio can operate in the millimeter wave band. Sufficiently fast transistors can be formed most naturally in high electron mobility, compound semiconductors. A silicon metal oxide semiconductor field effect transistor (MOSFET) of sufficiently short gate length, however, has been shown to have a sufficiently high switching speed to be able to operate in the mmw band. As a consequence of the rapid advancement of silicon CMOS technology, mmw band radios used in consumer applications are fabricated as IC module using the Si MOS process. In some embodiments of the present invention, the CMOS IC module can be treated, except for minor modifications, as existing technology.

A basic mmw transmitter and receiver pair, or mmw module, can have a standard super-heterodyne architecture with a single intermediate frequency (IF) stage, as shown for example in FIG. 5A. Embodiments of the present invention can implement the use of a global optical clock 300 that renders superfluous the phase locked-loop, voltage-controlled oscillator, and frequency synthesizer IC circuits. In their place, the optical clock can use a fixed transmission line delay, or fixed phase shift (φ), between the transmitter and receiver ICs at the clock frequency.

In some embodiments, the IC design can incorporate the optical clock signal both as a network clock in synchronizing data transfer and as a local oscillator in mmw transmission.

FIG. 5A illustrates a diagram of IC components comprising the mmw Tx/Rx module, which includes both a transmitter 600 and a receiver 700. The transmitter 600 includes a power amplifier (PA) 605; the receiver 700 includes a low noise amplifier (L/A) 705, while φ is a fixed relative phase shift. The shaded area of FIG. 5A indicates a single IF stage. Both the transmitter 600 and the receiver 700 includes an intermediate frequency variable gain amplifier (IFVGA) 610/710, a signal splitter (S) 715 or combiner (S) 615, an in phase data stream (I) 620/720, and a quadrature data stream (Q) 625/725. A photo detector (PD) 800 is used in the optical-to-electrical conversion of the optical clock signal 300.

In more detail, in the top branch or the receiver module 700, a wireless signal can be received by the antenna 701. The received signal can pass through the low noise amplifier 705. The amplified signal can then be mixed by a mixer 707. The mixer 707 can mix both the amplified signal from the L/A 705 and a local oscillator signal, originating from the optical clock 300, which has been phase shifted by φ and multiplied. For example, the phase shifted signal from the optical clock 300 can be quadrupled and then fed to the mixer 707 as the local oscillator signal. The mixed signal can then be transmitted to the IFVGA 710. This amplified signal of the IFVGA 710 can next be split via the splitter (S) 715. A first split signal is inserted to a mixer 717A, which also receives the optical clock signal 300 after it has been phase shifted by approximately 0° relative to the phase of the clock signal 300. The clock signal at the base clock frequency can be used directly as the intermediate frequency (IF) local oscillator (LO) signal for down-converting “in phase” or “I” stream data. The mixed signal from the mixer 717A is then amplified and filtered by an amplifier 719A and becomes the in phase data stream (I) 720. A second split signal of the splitter (S) 715 is inserted into a mixer 717B, which receives the optical clock signal 300 after it has been phase shifted by 90° relative to the phase of the clock signal 300. The clock signal at the base clock frequency is first phase shifted by approximately 90° and used directly as the intermediate frequency (IF) local oscillator (LO) signal for down-converting “quadrature phase” or “Q” stream data. The mixed signal from the mixer 717B is then amplified and filtered by amplifier 719B and becomes the quadrature data stream (Q) 725. The phase shifter φ is in electrical communication with the optical clock 300, which has been converted to an electrical signal via a PD module 800 from the optical clock signal 300.

As for the lower branch, or the transmitter module 600, the optical clock signal 300 is converted to an electrical signal via the PD module 800. At the intermediate frequency stage, the electrical signal is in communication with the clock frequency directly, which is in communication with both mixers 617A and 617B and provides the IF LO signal to both mixers. In the case of the “I” data stream, the LO signal is shifted in phase by approximately 0°. On the other hand, in the case of the “Q” branch the LO signal is shifted by approximately 90°. The in phase data stream (I) 620 can be amplified by an amplifier 619A. The amplified signal is mixed in the mixer 617A with the IF clock signal that has been phase shifted by approximately 0°. In a separate branch, the quadrature data stream (Q) 625 can be amplified by an amplifier 619B. This amplified signal is mixed in the mixer 617B with the IF clock signal that has been phase shifted by approximately 90°. The resulting mixed signals at the intermediate frequency stage from the mixers 617A and 617B are combined with combiner (S) 615. The combined signal is amplified via the IFVGA 615. The IFVGA amplified signals are then used to modulate the mmw carrier frequency in mixer 607. The mmw carrier frequency is obtained by quadrupling the optical clock frequency in multiplier 609. The modulated millimeter carrier wave from the mixer 607 can then be amplified via amplifier 605, and routed to the antenna 601 for transmission.

FIG. 5B illustrates the mmw RF platform 220 on which are assembled an array of Tx/Rx CMOS mmw modules 900 (whose components are shown in FIG. 5A), and the corresponding vertical antennas 701. Each mmw module 900 is connected to an antenna 701 by a short transmission line feed 803 configured to the mmw frequency range. A cross-sectional view of the optical clock drop is shown in more detail in FIG. 1B.

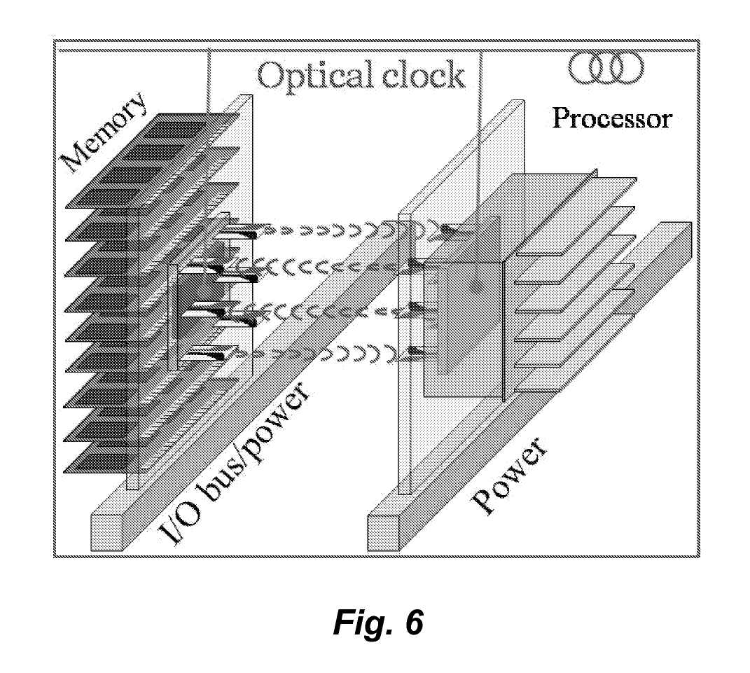

FIGS. 1A and 6 illustrate the processor and memory boards 100/200 aligned in a back-to-back orientation, thus being configured to transmit data wirelessly via near field coupling schemes. Each antenna element can be mounted approximately vertical on the RF platform to radiate normal relative to the plane of the board. The optical clock 300 can provide the self tracking and a correlated LO signal throughout the network. FIGS. 1B and 2 illustrates an optical drop in more detail and the cross-section of a packaged processor-to-RF platform electrical vias though the motherboard. A single optical drop on the RF platform can provide about 15 GHz electrical LO input to all Tx/Rx ICs on the RF platform.

In an exemplary embodiment, a network of bidirectional, wireless data channels, operating in the frequency band of about 55-95 GHz can be used to transfer data between processors and memory nodes distributed on separate boards within the computer box.

Many architectural features of the present wireless mmw data access network are generally illustrated in FIG. 1A. Referring to FIG. 1B, embodiments of the network generally include: (1) a plurality of processors 130 can be housed on one board 100 with low volume main memory as an external cache; (2) large main memory capacity 205 can be housed on a separate board 200; (3) the processor and memory boards 100/200 exchange data over radio waves in the mmw band; (4) the RF integrated circuit (IC) transceiver (Tx/Rx) arrays and the antenna radiator arrays are mounted on RF platforms on the back side of their respective boards 100/200; (5) through-board-vias 210 provide direct one-to-one I/O connections between processor I/O pads or memory node I/O pads and the respective RF Tx/Rx on the corresponding board; (6) a globally distributed optical clock 300 can perform several functions—specifically, the optical clock provides only one drop per processor or memory node, is converted to an electrical clock signal by a photo-detector and amplifier at the drop, and is distributed to all transmitter and receiver pairs associated with the particular processor or data node.

In some embodiments, the optical clock 300 is network wide distributed and is used to generate the RF millimeter carrier wave between about 55 and 95 GHz. The optical clock 300 also provides frequency and phase self tracking between mmw transmitter and receiver.

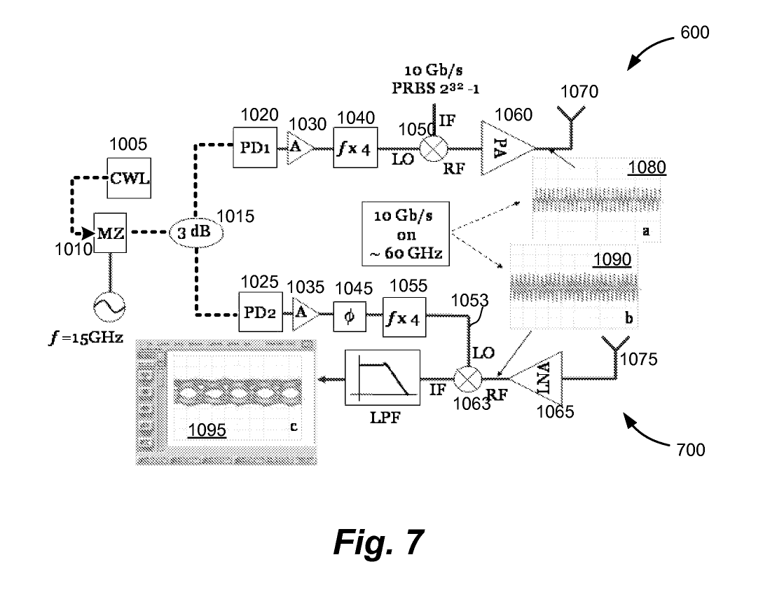

As shown in FIG. 7, a system of the present invention can include at least two mixers, at least two amplifiers, and at least one low pass filter, enabling the system to transmit data at a rate of about 10 Gb/s, using on-off key coding. The RF transceiver does not need a frequency synthesizer, phase-lock loop (PLL), or voltage controlled oscillator (VCO). Instead, these systems can be replaced by a single, global optical clock 300 distributed over the closed “network in a box” by optical fibers. The result is a network of low power, wireless I/O interconnects, well suited for high throughput memory access systems in high-end servers, mainframes or game boxes. The features of a mmw RF transceiver suitable for application in high throughput, wireless memory systems is illustrated in FIG. 7, where it is evident that purely electrical analog components can be used for RF frequency mixing, amplification and filtering. In FIG. 7, the optical path is represented by the dashed lines and the electrical path by the solid lines between elements.

The optical clock 300 can be generated, for example, by modulating the output of a continuous wave laser (CWL) 1005 with a Mach-Zehnder modulator (MZ) 1010, for example, at some convenient frequency f, such as about 15 GHz. Alternatively, another compact design may use a directly modulated laser and laser driver IC.

In either case, the laser 1005 and MZ modulator 1010, or the laser 1005 and its IC laser driver with a frequency generator, can be placed “outside the box” from the radio or the mmw network system. The clock signal 300 can be carried over optical fibers to the radio or the mmw network system.

In some embodiments, the optical clock signal 300 can be evenly split by an optical splitter 1015 (approximately 3 dB) and sent to separate photo-detectors (PD1) and (PD2) 1020 and 1025 for the transmitter (illustrated as the upper branch of FIG. 7) 600 and receiver (illustrated as the lower branch in FIG. 7) 700, shown in FIG. 7, where it is converted to an electrical clock signal and amplified by an amplifier (A) 1030/1035 in each branch.

In the upper branch or the transmitter 600 of FIG. 7, the amplified electrical clock signal can be approximately quadrupled via a multiplier 1040 in frequency to about 60 GHz and provide the LO signal for the mmw transmitter. The LO signal can provide the carrier wave that is amplitude modulated by the about 10 Gb/s data entering the mixer from the IF port 1050. The coded mmw from the RF port can be amplified via a power amplifier (PA) 1060 and fed directly to the antenna 1070 of the transmitter 600. Insert (a) 1080 is an example of an oscilloscope trace of the modulated millimeter carrier wave that can drive the transmitting antenna 1070.

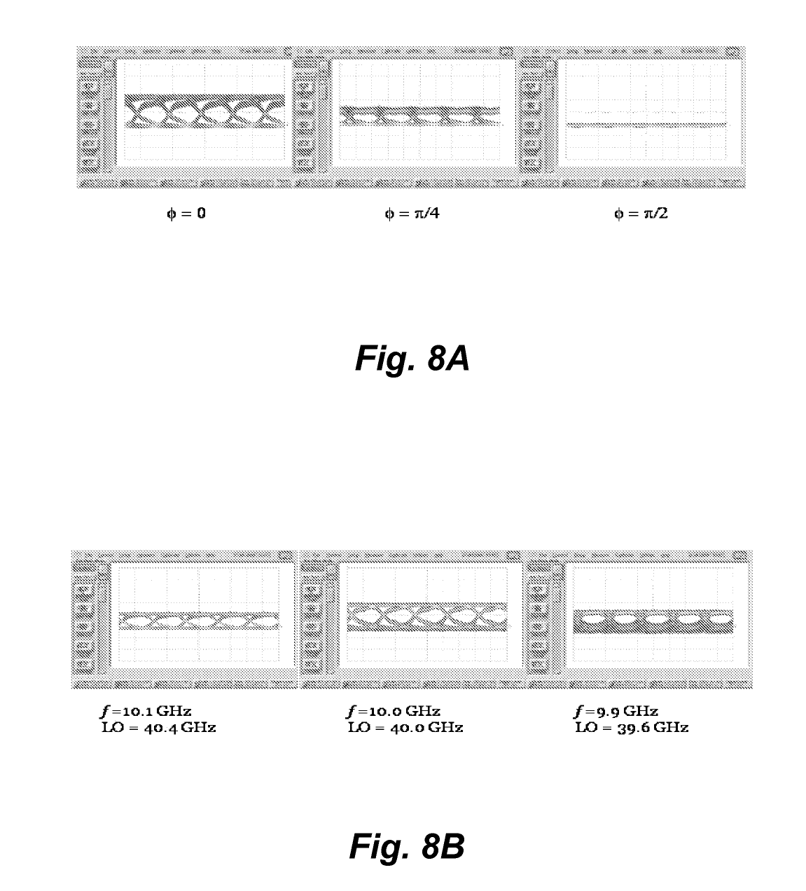

In the lower branch or the receiver 700 of FIG. 8, the electrical clock signal is amplified by an amplifier (A) 1035 and passes through an IF phase shifter (φ) 1045 that can be a fixed delay line. Following the phase shifter 1045, the electrical clock is approximately quadrupled in frequency, which can be handled via a multiplier 1055. Phase shifting of the LO signal 1053 in one of the branches can adjust the relative phase of the two LO waveforms and optimize mixing. The relative phase is optimized at least once. The mmw RF signal can be received by an antenna 1075, be amplified by a low noise amplifier (LNA) 1065, and enter the mixer 1063 in the receiver 700 where it is mixed with the receiver LO 1053 for IF recovery. The insert (b) 1090 is an example of an oscilloscope trace of the millimeter wave signal captured by the receiving antenna after amplification. Note that the amplitude has no particular significance, as it can be determined by the local amplifiers. The approximately 10 Gb/s data can be recovered from the received IF signal by using a simple RF filter, the output of which is displayed in the example oscilloscope trace (c) 1095.

The eye opening of the data generated, transmitted over mmw, and recovered in this simplified system is shown in insert (c) 1095. The adjustment can be the relative phase (φ) of the electrical clock frequency between the transmitter and receiver. The BER can be measured for three distances between transmitter and receiver antennae. The BER can remain virtually unchanged over distances of about 30 cm, 60 cm, and 90 cm at measured values of approximately 1.1×10⁻⁹ s⁻¹, 1.1×10⁻⁹ s⁻¹, and 1.0×10⁻⁹ s⁻¹, respectively, using a pseudorandom binary sequence having about 2³²−1 elements. An objective goal of a viable data interconnect is to achieve a BER of about 10⁻¹² s⁻¹ or better. This can demonstrate feasibility of a novel data interconnect architecture.

Further, embodiments of the present invention enable the ability to obtain frequency and phase stability and high data rates without using corrective elements characteristic of full radios, such as PLL or VCO for each Tx and Rx stage. In addition, the mmw carrier can be directly derived from the optical clock and thus no frequency synthesizers are needed. The globally distributed optical clock can self track presumed small frequency and phase drifts that may arise from MZ modulation (or direct laser current modulation) and a several meter length optical fiber.

In an exemplary embodiment, frequency and phase stability was demonstrated experimentally in FIG. 8A and FIG. 8B using a previous test bed operating with a frequency (f) of approximately 10 GHz and a quadrupled frequency (4f) of approximately 40 GHz. The data rate can be approximately 2.5 Gb/s, being limited by frequency band-pass of the power amplifier in the transmission channel. FIG. 8A illustrates an exemplary behavior of the received signal as the relative phase (φ) between the LO signals for the transmitting and receiving channels can be systematically varied between about 0° and 90°. The received signal loss when φ=90° may provide a means for reducing cross talk from adjacent radiating and receiving antennas. Thus, the relative phase between nearest neighbor LO transceivers may be set with a relative phase of 90°.

FIG. 8B illustrates an exemplary behavior of the received signal as the MZ modulation frequency f is de-tuned by about 100 MHz out of about 10 GHz, or approximately 1%, when both the transmitter and receiver channels are optimized for about 40 GHz LO operation. An approximate 1% frequency de-tuning is quite large for an RF system.

The global optical clock can reduce the complexity of each RF transmitter and receiver unit throughout the network. As noted above, the frequency synthesizer, the PLL and VCO can be removed from each unit. As a result, component redundancy is removed and power dissipation can be substantially reduced. In addition, the frequency synthesizer can be removed because the carrier wave signal can be derived from the optical clock signal. Phase and frequency drift in the optical oscillator and optical fiber clock distribution is self tracking with reasonably large variations. Therefore, the PLL and VCO systems are not needed.

To estimate the power dissipation in the architecture of the embodiments of the present invention, the estimated power dissipation can be extracted for the major integrated blocks, namely the PA, LNA, and mixer, and then estimating the power dissipation for each (Tx+Rx) pair. To this sum, the power dissipation can be added at each optical clock drop. This includes the estimated power dissipated by the single photo-diode (PD) and its amplifier (A1) at each optical clock drop and the single electrical amplifier (A2) for the electrical clock distribution to each (Tx+Rx) pair at each drop. This dissipated power can then be divided by the number of (Tx+Rx) pairs at each clock drop and added as the contribution to each RF transceiver pair. The power dissipation in generating the optical clock can be estimated by assuming an edge emitting laser, an integrated IC laser driver, and an integrated IC frequency generator are placed outside the mmw interconnect network. This dissipated power can be divided by the number of optical drops per network and the number or transceiver pairs per drop and added as the contribution to each RF transceiver pair. The estimated power dissipation is summarized in Table I. As shown below, in Table I, components of an exemplary mmw wireless data interconnect are shown in the left most column; the estimated power dissipation for each RF IC component is estimated, and the estimated power dissipation for the optical clock components are listed in the middle column; and the contribution to the total power dissipation per Tx/Rx unit is listed in the right most column.

TABLE I

| | Total | Power per |
|---|---|---|
| | power | RF Tx/Rx |
| mmw Components | (mW) | unit (mW) |
| RF Transceiver | | |
| 1 LNA (705) | ~29 | |
| 1 PA (605) | ~54 (25) | |
| 2 mixers (607/707) | ~10 | |
| 2 4f (609/709) | negligible | |
| 1 LPF | negligible | |
| Total | ~103 (~74) | ~103 (~74) |
| Optical Drop | | |
| 1 PD (800) | negligible | |
| A1 | ~140 | |
| A2 | ~100 | |
| Total (for 50 Tx/Rx units) | ~240 | ~4.8 |
| Optical Clock | | |
| DFB or FP | ~200 | |
| Laser + driver | | |
| Oscillator | ~300 | |
| Total (for 500 Tx/Rx units) | ~500 | ~1 |

An estimate total power dissipated for each mmw data interconnect channel is shown in Table I as having three contributions: RF Tx/Rx of approximately 103 or 74 mW, depending on the power of the power amplifier; optical drop of approximately 4.8 mW (assuming 50 Tx/Rx transceiver I/O per drop); optical clock of approximately 1 mW (assuming 10 optical drops serving 50 Tx/Rx transceiver each). The total power per Tx/Rx mmw data interconnects is between approximately 79.8 and 108.8 mW. For a data rate of about 10 Gb/s, in an exemplary experiment in which simple on-off data modulation is used as with an ordinary copper bus, an estimate of normalized power dissipation can be between approximately 8 and 10.9 mW/Gb/s.

The optical clock generator can be placed “outside the box” relative to the radio, and the clock signal distributed over optical fibers to optical drops in the network that may be completely contained in a vertical rack. For example and not limitation, the optical clock can be generated by a single laser operating at commercially standard communication wavelengths of about 850 nm, 1310 nm, or 1550 nm.

In some embodiments, a packaged processor chip in its socket can occupy an area of approximately 5 cm×5 cm and the space between adjacent boards can be approximately 4-5 cm. The RF radiator may be the largest RF component and can be a single, composite thin film element on a ceramic substrate measuring approximately of approximately 3.5 mm×4.5 mm. Mounting the antenna out of the plane of the board and on the back side can preserve board real estate and reduce the distance of the antenna feed by going directly from a processor I/O pad, through a via to the back side of the board and directly to the Tx/Rx transceiver IC. Aspects of antenna design in this case are: out of plane mounting, compact size, polarization, wide bandwidth, and for longer distances, high gain.

### EXAMPLES

The following non-limiting examples are included to illustrate modes of the presently disclosed subject matter. In light of the present disclosure and the general level of skill in the art, those of skill will appreciate that the following non-limiting examples are intended to be exemplary only and that numerous changes, modifications, and alterations can be employed without departing from the scope of the presently disclosed subject matter.

### Example 1

### Application of mmw Data Bus in Modular CPS Network

The system illustrated in FIG. 6 can provide an example of the application of the mmw data bus in a CPS system. The system includes components for cyber functions, including a logical unit and a memory unit. The memory I/O bus can carry power and data over a conventional copper bus or optical I/Os that links the main memory to a cyber network with which it may be shared. The processor power bus can carry power to the processor. The main memory is mounted on one side of the memory board. On the backside can be a millimeter wave RF platform, similar to one shown in FIG. 1B. The backside can also carry a memory controller, serializers/deserializers (SER/DES), and multiplexers/demultiplexers (MUX/DMUX) to match the slow DRAM access speed with the high throughput mmw data bus and the fast processor I/Os. The optical clock can be used to synchronize each high performance cyber unit in the CPS network, synchronize the data transfer between processor and memory controller, and provide the local oscillator signal for each wireless channel. At least one, and in some embodiments only one, optical clock drop can be implemented for each mmw RF platform containing the array of millimeter wave channels, as discussed above. Because the DRAM memory access time is expected to remain at about 10⁻⁹ s, the data rate for the copper bus linking the DRAM I/O pins and the memory controller need not be very high. High bandwidth data transfer occurs wirelessly between the processor and memory controller. Consequently, a substantial volume of main memory may be placed on the memory board at some distance from the point of high speed transmission. Both the processor and main memory boards may be pluggable on their respective buses.

As illustrated in FIG. 6, a diagram of the basic cyber unit in which the processor sub-mount and main memory sub-mount exchange data via the millimeter wave wireless bus. High throughput data transactions can occur wirelessly. Memory transfer operations such as multiplex/demultiplex, pre-fetch and synchronization, can be handled by a memory controller circuit integrated on the mmw RF platform on the memory sub-mount. Two optical clock drops are represented in the figure by the two dots on the processor and memory sub-mounts. A cross sectional sketch of the optical drop main components is shown in FIG. 1B.

The configuration illustrated in FIG. 6 can be made compact and portable and can be used to physically reconfigure, as opposed to software re-configurable, a CPS. Once interfaces for power and data have been developed and standardized between a compute unit and the remaining CPS system, it becomes straightforward to exchange computation units and stored programs. For example, a compute unit can be removed from the standard interface of a fixed wing aircraft physical unit and inserted into the standard interface for a helicopter physical unit and the stored program switched accordingly.

### Example 2

### Application of the mmw Data Bus in Large Cyber Physical Systems

This example can include peta-flop computers in data centers as well as tera-flop servers or departmental machines in legacy corporations. Multiple processor dies can be integrated on a motherboard with some main memory. The large memory capacity may be mounted on a neighboring board. The two boards exchange data directly over mmw in the approximately 50 to 90 GHz band using an antenna arrays (see, e.g., FIGS. 5A-6). Because data transfers can occur via near field interaction, mmw energy does not leaves the box and licensing restrictions do not apply.

In one example of board-level integration, the Tx/Rx antenna arrays can be mounted on a mmw RF platform on the back side of the respective board, as shown in FIG. 1A, and conductive vias through the board provide direct one-to-one I/O connections between processor I/Os (or memory controller I/Os) and the respective mmw IC module and Tx/Rx antenna on the RF platform, see, e.g., FIG. 1B. An optical drop on each RF platform can provide an approximate electrical 15 GHz correlated LO signal to each Tx/Rx pair on that platform. The memory controller may connect to a multiplexer/demultiplexer to make full use of the available mmw data bandwidth.

Digital symbol coding and decoding—for example and not limitation quadrature phase shift key (QPSK) which can carry two bits of data for each symbol of modulation of the carrier wave, or quadrature amplitude modulation (QAM) which can carry four bits of data for each symbol of modulation of the carrier wave—can be used to obtain higher data bandwidth efficiencies. In principle, RF frequency modulation provides scalability in data throughput by increasing the number of bits that a symbol can carry. A limit is imposed by signal-to-noise-ratio (S/N) and the increased power dissipation needed to achieving sufficiently low S/N rations. In some examples, the target bit error rate is about 10⁻¹² s⁻¹ while maintaining the signal/noise ratio close to the theoretical limit so as to be frugal with power consumption.

A second innovative principle of this example after the use of the common source global optical clock is an embodiment of transferring data using the spatially strongly varying EM waves within one to three wavelengths of the antenna radiator, well short of the far field asymptotic limit. This high frequency near-field is distinct from a low frequency inductive or capacitive near field coupling in that both the electric and magnetic fields couple strongly to the receiver antenna at high frequencies through, for example, a Poyinting vector.

While exemplary embodiments of the invention have been disclosed many modifications, additions, and deletions can be made therein without departing from the spirit and scope of the invention and its equivalents, as set forth in the following claims. In addition, the quantities of various features of embodiments of the present invention are provided for illustrated embodiments and are exemplary. The scope of the various embodiments of the present invention should not be limited to the above discussed embodiments or quantity values, and should only be defined by the following claims and all applicable equivalents.

What is claimed is:

1. A wireless communication system configured to transmit data from a first location to a second location, the wireless communication system comprising:
an optical signal providing network coherence, frequency self-tracking, phase self tracking, and a local oscillator signal for data digital symbol coding/decoding and symbol up-down conversion; and
a communication device configured to operate in conjunction with the optical signal.

2. The wireless communication system of claim 1, wherein the optical signal is converted to an electrical signal for use by the communication device.

3. The wireless communication system of claim 2, the communication device comprising a receiver element configured to receive a signal and a transmitter element configured to transmit a signal.

4. The wireless communication system of claim 1, wherein the optical signal is approximately a 15 GHz optical clock provided to the communication device, and wherein the optical signal is received by a photoreceptor and converted to an electrical signal.

5. A radio frequency (RF) system comprising:
a plurality of RF channels adapted to transmit data between two locations in space, each of the plurality of RF channels comprises a transmitter element and a receiver element; and
an optical signal configured to be distributed to each transmitter element and each receiver element of each of the plurality of radio frequency channels.

6. The RF system of claim 5, the optical signal providing network coherence, frequency self-tracking, phase self tacking, and a local oscillator signal for data digital symbol coding/decoding and symbol up-down conversion.

7. The RF system of claim 5, each of the plurality of RF channels further comprising a transmitter antenna and a receiver antenna in a radar and beam-forming orientation, enabling a transmitter antenna of a first of the plurality of RF channels to interact with a receiver antenna of a second of the plurality of RF channels.

8. The RF system of claim 7, wherein each antenna in the RF system is isolated from all other antennas.

9. The RF system of claim 7, each transmitter antenna transmits data using near field interaction in a Poyinting vector coupling mode.

10. The RF system of claim 5, wherein the optical signal is converted to an electrical signal for processing and to be used by the plurality of RF channels.

11. A wireless communication system comprising:
a processor board adapted to carry a plurality of processors on a first surface, the plurality of processors in electrical communication with a transceiver on a second surface;
a memory board adapted to carry a plurality of storage media on a first surface, the plurality of storage media in electrical communication with a transceiver on a second surface; and
an optical signal provided to the processor board and the memory board.

12. The wireless communication system of claim 11, the transceiver carried by the processor board and the transceiver carried by the memory board adapted to communicate with one another.

13. The wireless communication system of claim 11, the transceiver of by the processor board and the transceiver of by the memory board adapted to operated at millimeter wave frequencies.

14. The wireless communication system of claim 11, further comprising an electrical circuit comprising:
a first photo detector for receiving the optical signal and adapted to convert the optical signal to an electrical signal;
an amplifier configured to amplify the electrical signal from the first photo detector;
the amplified electrical signal in electrical communication with the transceivers of the processor board and the memory board.

15. The wireless communication system of claim 11, the transceiver of the processor board and the transceiver of the memory board each comprising a transmitter with a transmitter Vivaldi antenna for transmitting a wireless signal and a receiver with a receiver Vivaldi antenna for receiving a wireless signal.

16. The wireless communication system of claim 11, the optical signal operating at approximately 15 GHz, and the processor board and the memory board having a millimeter wave feed of approximately 60 GHz.

17. The wireless communication system of claim 11, the processor board and the memory board in wireless communication with one another via receiver and transmitter antennas operating via near field communications.

18. The wireless communication system of claim 11, the optical signal providing an optical clock signal providing network coherence, frequency self-tracking, and a local oscillator signal for data digital symbol coding/decoding and symbol up-down conversion.

19. The wireless communication system of claim 18, wherein the optical clock signal eliminates the need of a frequency synthesizer system, a phase locked-loop (PLL) system, and voltage controlled oscillator system in the wireless communication system.
